(19) United States
(12) Patent Application Publication
(10) Pub. No.: US 2025/0218177 A1
(43) Pub. Date: Jul. 3, 2025

(54) SEQUENCE RECOGNITION IN VIDEO

(71) Applicant: Sorenson IP Holdings, LLC, Salt Lake City, UT (US)

(72) Inventors: Shashank Bujimalla Venkata Sesha, Portland, OR (US); Abolfazl Zargari Khuzani, Campbell, CA (US); Mariam Rahmani, Folsom, CA (US); Abolfazl Ravanshad, Redwood City, CA (US); Naveen Kulkarni, Folsom, CA (US)

(21) Appl. No.: 18/398,861

(22) Filed: Dec. 28, 2023

(51) Int. Cl. G06V 20/40; G06V 10/82; G06V 40/20

(52) U.S. Cl. CPC G06V 20/41; G06V 10/82; G06V 20/46; G06V 40/28

(57) ABSTRACT

System and techniques to recognize sequences in video using a transformer are described herein. The transformer uses a local-chunk attention mechanism to discretize activities in the sequence in the video. The transformer may also employ relative positional encodings to address the temporal nature of activities in a sequence within the video.

### BACKGROUND

A neural network is a computational model inspired by the structure and functioning of biological neural networks, primarily used in the field of machine learning and artificial intelligence. Generally speaking, a neural network has of layers of interconnected nodes, called neurons. These neurons process input data, transmit signals to other neurons, and produce output. The strength of these connections, or weights, is adjusted during the training process to optimize the network's performance for specific tasks.

Neural networks come in various architectures that may be more appropriate for different types of data and tasks. For example, Feedforward Neural Networks (FNNs) are the simplest type of neural network where the connections between the nodes do not form a cycle. FNNs may be used for general prediction and classification tasks. Recurrent Neural Networks (RNNs) and designed for processing sequential data, such as time series or text. RNNs have connections that form cycles, allowing them to maintain a form of ‘memory’ of previous inputs. Convolutional Neural Networks (CNNs) are usually used in image processing and computer vision. CNNs employ a mathematical operation called convolution which enables them to efficiently process data with a grid-like topology, such as images. Long Short-Term Memory Networks (LSTMs) are a special kind of RNN with a facility to learn long-term dependencies. LSTMs are useful in language modeling and other sequence tasks. Generative Adversarial Networks (GANs) use two networks, a generator and a discriminator, which are trained simultaneously. GANs are often used in image generation and style transfer. Transformers (e.g., Transformer Networks) use a self-attention mechanism.

The transformer architecture is a model that has been successful in natural language processing (NLP), such as in large language models (LLMs). Transformers are a shift from the sequential data processing of traditional recurrent neural networks (RNNs) to a focus on a mechanism known as ‘self-attention’. In the transformer model, the self-attention mechanism operates to consider the relevance of different words in a sentence, irrespective of their positional distance (e.g., the relevance of the first word in the sentence to both the second word and the fifth word). This approach differs from earlier methods that processed data in a linear sequence. The architecture of the transformer usually uses an encoder, which is responsible for processing the input data, and a decoder, which is used for generating the output from the result of the encoder (e.g., an encoding of the input data).

### BRIEF DESCRIPTION OF THE DRAWINGS

In the drawings, which are not necessarily drawn to scale, like numerals may describe similar components in different views. Like numerals having different letter suffixes may represent different instances of similar components. The drawings illustrate generally, by way of example, but not by way of limitation, various embodiments discussed in the present document.

FIG. 1 is a block diagram of an example of an environment including a system for sequence recognition in video, according to an embodiment.

FIG. 2 is an example of a transformer architecture with chunk-wise attention, according to an embodiment.

FIG. 3 is an example of a transformer architecture with chunk-wise attention and relative positioning, according to an embodiment.

FIG. 4 illustrates a flow diagram of an example of a method for sequence recognition in video, according to an embodiment.

FIG. 5 is a block diagram illustrating an example of a machine upon which one or more embodiments may be implemented.

### DETAILED DESCRIPTION

Automatic recognition—and, for example, transcription—of activity sequences in video has utility across various applications. Because meaning for any given activity in a sequence may affect another that is not directly proceeding, a transformer may be used to provide such recognition. The training of such transformers typically involves extensive training datasets of videos, each labeled correspondingly. However, not every domain possesses datasets of such magnitude. A notable challenge arises when a standard transformer is trained directly on videos featuring sequences of activities. In this scenario, the model may tend to memorize the order of activities from the training data, leading to reduced efficacy in generalizing to new sequences during inference. This issue stems from the model's design, where the self-attention mechanism incorporate all frames of a video, thereby using every activity in the video to generate the transcription and learn the context. When training datasets are limited in size, transformer models face a shortage of data variations to comprehensively learn the context and possible activity variations. In real-world situations, encountering sequences of activities that differ from those in the training data is a common occurrence.

For example, consider a sequence of activities such as is present in sign-language. A standard transformer may be directly trained on videos that represent sentences (e.g., sequences of signs). Such transformers may exhibit a tendency to memorize the sequence of signs in the training data, consequently exhibiting limited generalization capabilities when presented with novel sentences during the inference stage. This limitation may be attributed to several factors. As noted above, the conventional transformer uses all frames in a video in the attention mechanisms, thereby utilizing every sign in the video for generating translations. Also, existing datasets for sign language are relatively limited in size and lack standardized grammatical structures. As a result, transformer models are often deprived of the necessary variety in sentence data to effectively learn the context and the full spectrum of variations inherent in sign language. Further, in practical scenarios, users frequently construct sentences with a novel arrangement of signs, such as fingerspelling a name or a reservation number. Accumulating training data that encompasses all potential combinations of sign sequences is an impractical endeavor.

To address these issues, a sequence-to-sequence transformer may be used. The sequence-to-sequence transformer modifies several aspects of the standard transformer architecture to enable direct training on videos containing sequences of activities while significantly reducing the risk of learning context or memorizing the order of activities seen in the training videos. For example, the sequence-to-sequence transformer uses a “local chunk attention” mechanism rather than the “full self-attention” mechanism of standard transformers. In an example, the sequence-to-sequence transformer uses “relative position encodings” for tokens rather than the “absolute position encodings” typical in standard transformers. The sequence-to-sequence transformer enables the effective use of videos that showcase both sequences and individual activities for training on data sets that may be limited in number or variety with enhanced accuracy and generalizability to activity sequences not encountered in the training data than is possible with standard transformer architectures. Additional details and examples are provided below.

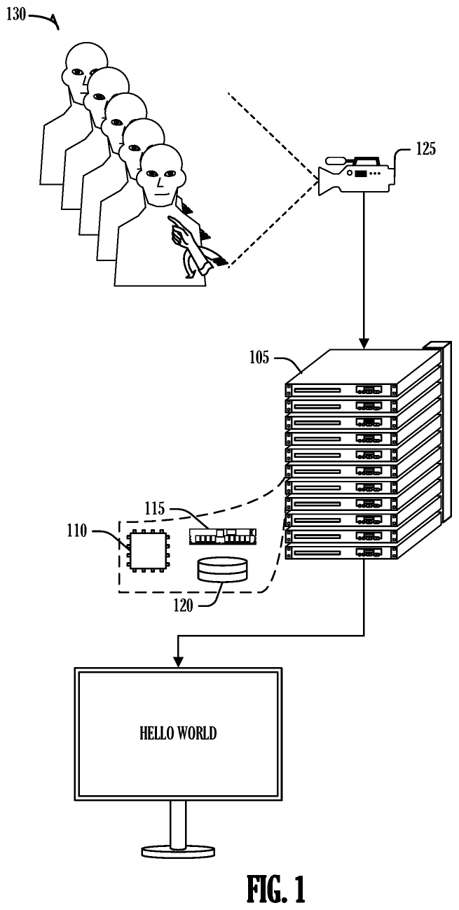

FIG. 1 is a block diagram of an example of an environment including a system 105 for sequence recognition in video, according to an embodiment. The system includes processing circuitry 110 (e.g., a central processor unit (CPU), GPU, etc.), storage 120 (e.g., a hard drive, solid-state drive, storage class memory, etc.), and working memory 115 (e.g., volatile random access memory (RAM)). For clarity, the following examples use the processing circuitry 110 as the entity effectuating the techniques, however, other combinations of hardware or software may be used, such as a cloud service, cluster, etc.

The processing circuitry 110 is configured to obtain (e.g., retrieved or received) video (e.g., from camera 125) that includes a sequence of activities 130. In an example, the activities are gestures by a human being. In an example, the activities are signs in a sign language. Sign language provides a very good example of a sequence of activities in which the meaning of any given activity may be modified by preceding or proceeding activities, just as a word in a paragraph may be modified by words preceding or proceeding the word in the paragraph. Although the context of a sign in a sequence of signs may be stronger, the sequence may be any set of activities where the order of action impacts the meaning of the event. For example, a person tripping may be accident if not immediately proceeded by a push from another person. Other sequences may include aspects of a running, or other sporting gate, reactions between chemicals or other experimental observations, etc.

The processing circuitry 110 is configured to invoke (e.g., run, execute, apply, etc.) a sequence-to-sequence transformer on the video to produce a set of labels that correspond to activities in the sequence of activities 130. The sequence-to-sequence transformer is a new transformer architecture that is more suited to sequential events such as those that are often presented in video. A chunk-wise attention mechanism is an aspect of the sequence-to-sequence transformer that differs from the traditional transformer. Accordingly, in an example, the sequence-to-sequence transformer is configured to use chunk-wise attention. In an example, chunk-wise attention includes dividing inputs into chunks and applying attention within a chunk. In a traditional transformer, the attention mechanism, whether multi-head or single head, is a matrix that provides a set of values (queries, keys, and values) based on a present neuron and an input set. These values relate, for that neuron, the relevance of the inputs. Typically, in a traditional transformer, full-self-attention—where every input is related to every other input—is used. In contrast, chunk-wise attention limits the elements that are considered by the attention mechanism to discrete chunks. This helps to contextualize a given activity to local activities (e.g., those activities immediately preceding or proceeding the activity) to avoid trying to “learn” an entire sequence of activities (e.g., signed sentence in sign language) and instead “learn” individual activities (e.g., signs in sign language). This enables a smaller training dataset to be used and also increases generalizability with respect to activities or variations of activities that have not be trained.

In an example, an input layer and optionally multiple layers above it also use local attention from neighboring chunks. Here, a neighborhood around the chunk, called a slide, is also considered by the attention mechanism. This addresses an issue where the chunk-size does not fit an activity (e.g., the chunk includes only part of a sign). The peek into neighboring chunks helps to capture missing parts of the sign on input ingestion. This correction is helpful when, for example, the sequence-to-sequence transformer does not have a decoder. The decoder of a traditional transformer may auto-regressively capture an entire signed sentence rather than the individual signs, and so eliminating the decoder helps to prevent this unfavorable result.

In an example, the attention in the sequence-to-sequence transformer is bi-directional with respect to time for input to the sequence-to-sequence transformer. For example, for a given video frame, the attention mechanism considers frames that are both forward and backward in the sequence of video frames. This helps to identify the “activity” when that activity may span multiple video frames. For certain applications (e.g., real-time inference of a streaming video), where video frames succeeding a given frame may not be available to apply bi-directional attention, this transformer model may be unidirectional with respect to time, which may generate better results.

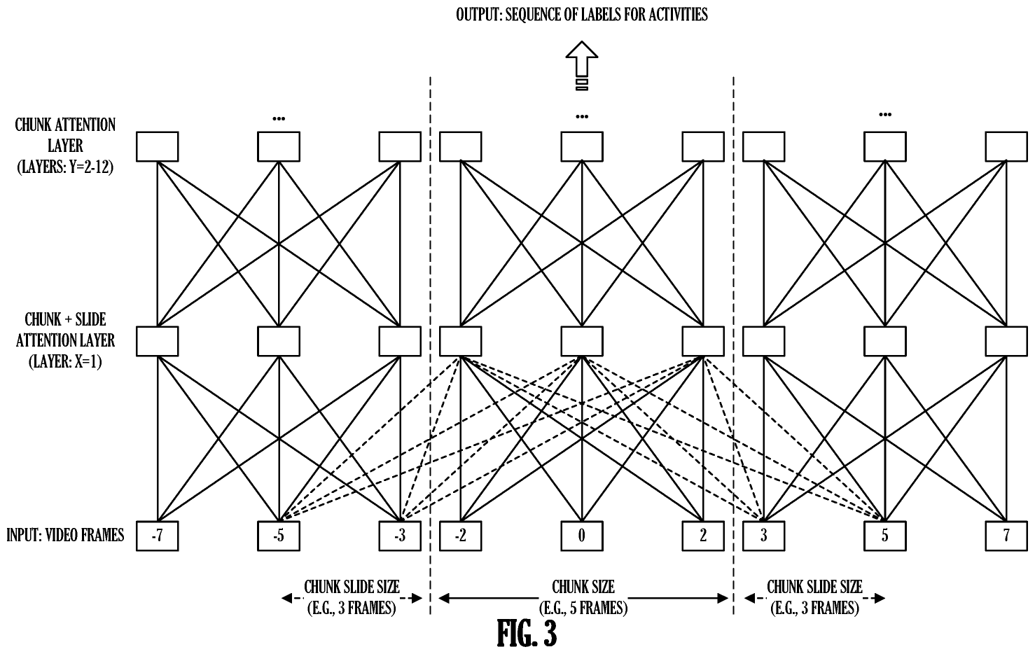

In an example, position encodings of the sequence-to-sequence transformer are relative with respect to self-attention calculations. Generally, the attention mechanism is unaware of where another element in a context is. This information is conveyed with position encoding of the data (e.g., video frames). In a traditional transformer, the positions are absolute with respect to the context. Thus, for example, the first word in a sentence is encoded as having the position of the first word in a sentence. Relative encodings apply a positional encoding based on the observation element. Thus, a video frame under consideration, such as frame eight, has a positional encoding of zero, the preceding frame an encoding of negative one, and a proceeding frame a positional encoding of positive one. These relative positional encodings are applied on all the video frames under consideration. FIG. 3 illustrates an example of this arrangement.

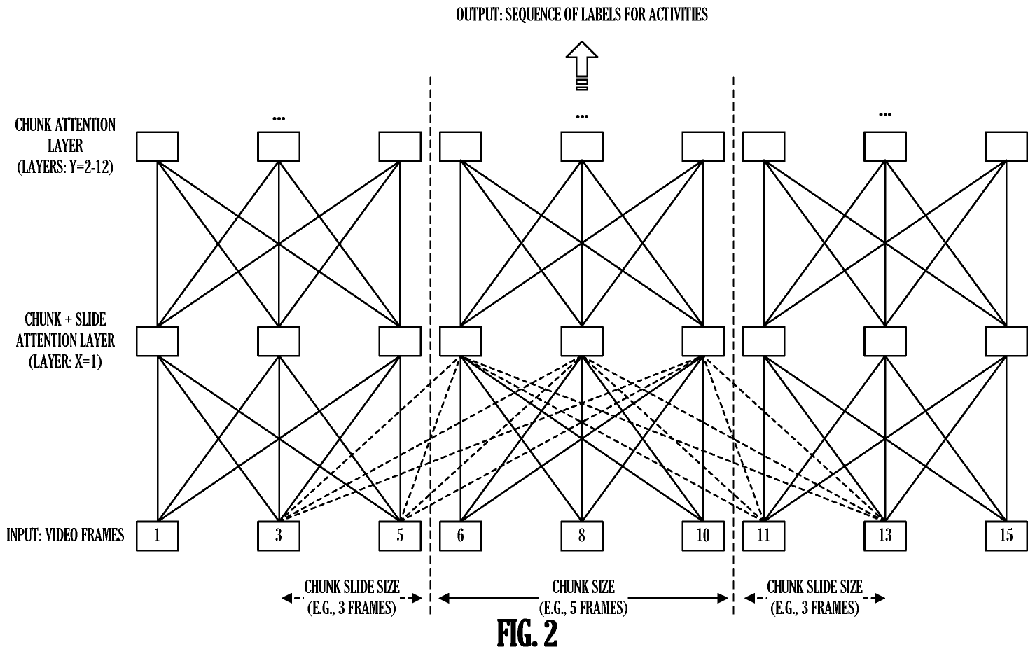

The following is another expression of the sequence-to-sequence transformer. In an example, the sequence-to-sequence transformer includes an input-embedding layer configured to encode an input sequence to an encoded input sequence, and an encoder neural network comprising one or more encoder subnetworks. These one or more encoder subnetworks include a base encoder subnetwork—such as the chunk+slide layer illustrated in FIG. 2 and FIG. 3—that accepts the encoded input sequence as input.

Any given encoder subnetwork has an encoder self-attention sub-layer and a feedforward sub-layer. In an example, the encoder self-attention sub-layer is configured to receive subnetwork input and apply a local-chunk attention mechanism over the subnetwork input to generate queries, keys and values (e.g., the usual output for transformer attention mechanisms). The local-chunk attention mechanism restricts the attention mechanism for a neuron of the encoder subnetwork to a subset of the subnetwork input based on a predetermined chunk size. This is the chunk referred to earlier. In an example, the local-chunk attention mechanism is bi-directional. For certain applications (e.g., real-time inference of a streaming video), where video frames proceeding a given frame may not be available to apply bi-directional attention, this local chunk-attention mechanism may be unidirectional to generate better results.

In an example, the encoder self-attention sub-layer for the base encoder subnetwork is configured to expand the attention mechanism to include a portion of the subnetwork input that adjacent to the subset of the subnetwork input. This is the slide illustrated in FIG. 2 and FIG. 3, to capture data immediately surrounding the chunk. In an example, the portion of the subnetwork input is a predetermined fixed number of elements of the subnetwork input. Thus, the slide has a fixed size.

The feedforward sublayer is configured to apply a transformation to the subnetwork input based on the queries, keys, and values to produce encoder subnetwork output, and transmit the encoder subnetwork output to a recipient. Thus, this portion of the sequence-to-sequence transformer facilities standard transformer connectiveness and training.

In an example, the sequence-to-sequence transformer does not include a decoder neural network. In an example, the input-embedding layer is configured to apply relative positional encoding to the input sequence. In an example, the relative positional encoding are bi-directional. In an example, the input sequence comprises video frames. In an example, the chunk size is a number of video frames that are equivalent to a second or a few seconds.

The material above describes the structure and operation of the sequence-to-sequence transformer. In an example, where the activities are human gestures, the video frames may be modified or replaced. In an example, a pose by the human being is modeled and skeletal key points are extracted from the pose. Here, a product such as Mediapipe may be used to gather this data. The skeletal key points (e.g., a stick figure of the person's limbs and body) may enable a less-noisy dataset from which the sequence-to-sequence transformer will infer labels for the activities. Accordingly, in an example, the skeletal key points of the pose are provided as input to the sequence-to-sequence transformer.

In an example, where the activities are signs in a sign language, the labels are glosses for the sign language. A gloss is a singular label for a sign, similar to how “cat” represents a certain type of mammal. However, a gloss is not a definition and often doesn't convey the entire meaning of a sign out-of-context. This is similar to a literal translation of words from one written language to another; often the meaning is lost.

The processing circuitry 110 is configured to communicate the set of labels. Here, the communication may be displaying glosses on a monitor as illustrated. The communication may also include transmitting the set of labels, storing (e.g., in the storage 120) the set of labels, or otherwise communicating the set of labels. These labels may be used in, for example, an LLM translation to another language, in which the glosses, in context, may be better interpretated for consumption by others.

FIG. 2 is an example of a transformer architecture with chunk-wise attention, according to an embodiment. The base, or bottom, layer is labeled as the chunk+slide layer and is next to the input. The illustrated chunk size is five video frames. Note that the inter-neuron attention (solid lines) is confined within chunks. However, the base layer also employes adjacent attention (e.g., additional local attention) illustrated as dashed lines across the chunk boundary to the slide size. The number of such layers with additional local attention from neighboring chunks is configurable; This may be set as just the bottom layer, or bottom layer along with a few layers above it, or all the layers in the transformer model.

The illustrated transformer differs from a traditional transformer in several ways. For example, the illustrated transformer replaces the “full self-attention” of a traditional transformer to chunk-wise (e.g., “local chunk attention”) as illustrated. In top layers of model (as illustrated) the chunk-wise attention is used and in the bottom layer of model the additional local attention from neighboring chunks is also used.

In an example, data input to the model is different than in traditional models. For example, instead of using a frequency image (e.g., audio input converted to Mel-spectrogram), video input may be converted to Mediapipe key points (e.g., a pose video).

The chunk-wise attention is used to avoid learning context from the entire sequence of activities (e.g., a sentence in sign language) and to only look at frames of individual activities (e.g., signs in sign language). However, the decoder of a traditional transformer may learn the entire context if used in an auto-regressive fashion. Thus, in an example, the illustrated transformer does not have a decoder. In an example, small chunk sizes are used to avoid learning context. Small is based on the subject activity. For example, for signs in sign language, chunks may be between five and twenty frames at fifteen to thirty frames-per-second to cover about one second of video.

Because activity boundaries are not known beforehand, the additional local attention from neighboring chunks enables cross-chunk activities to be identified.

In an example, the self-attention of the illustrated transformer is bi-directional because activity recognition works better if all frames of an activity are used instead of only the prior frames getting used. This is in contrast to unidirectional attention mechanisms that only look backward. For certain applications (e.g., real-time inference of a streaming video), where video frames proceeding a given frame may not be available to apply bi-directional attention, the proposed transformer model may be trained using unidirectional attention mechanism.

FIG. 3 is an example of a transformer architecture with chunk-wise attention and relative positioning, according to an embodiment. The illustrated transformer differs from that illustrated in FIG. 2 by changing “absolute position encodings” To “relative position encodings.” Again, to avoid learning context for an entire sentence in sign language, during self-attention calculation, relative positions of other frames with respect to a current frame in both directions (before and after current frame) are used. As illustrated, the relative positions (numbers) are relative to what was frame 8 in FIG. 2. Note the bi-directional encoding resulting in negative and positive relative positional encodings.

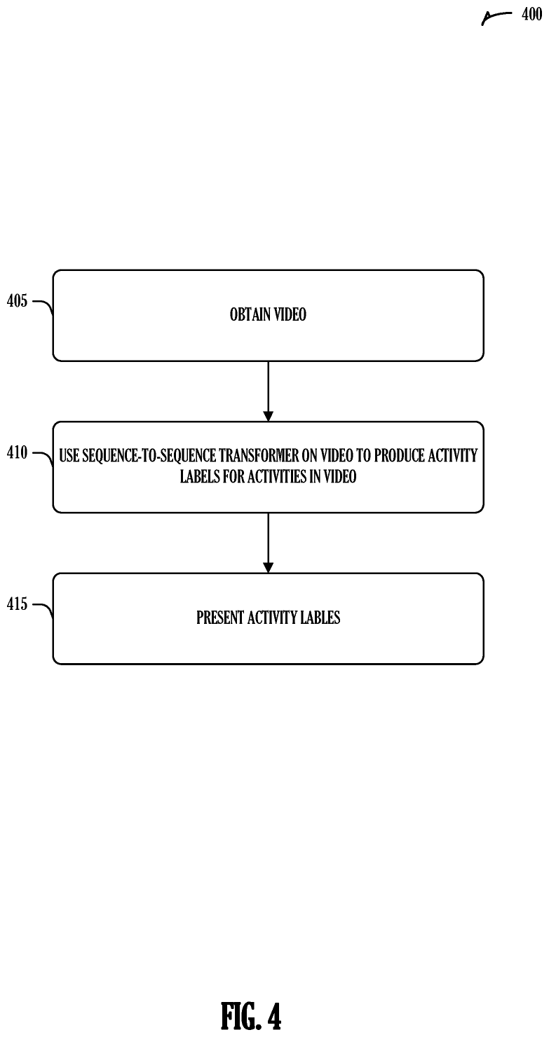

FIG. 4 illustrates a flow diagram of an example of a method 400 for sequence recognition in video, according to an embodiment. The operations of the method 400 are performed by computational hardware such as that described above or below (e.g., processing circuitry).

At operation 405, video that includes a sequence of activities is obtained (e.g., retrieved or received). In an example, the activities are gestures by a human being. In an example, the activities are signs in a sign language.

At operation 410, a sequence-to-sequence transformer is invoked (e.g., run, executed, etc.) on the video to produce a set of labels that correspond to activities in the sequence of activities. In an example, the sequence-to-sequence transformer is configured to use chunk-wise attention. In an example, chunk-wise attention includes dividing inputs into chunks and applying attention within a chunk. In an example, an input layer also uses local attention from neighboring chunks.

In an example, the attention in the sequence-to-sequence transformer is bi-directional with respect to time for input to the sequence-to-sequence transformer. In an example, position encodings of the sequence-to-sequence transformer are relative with respect to self-attention calculations. In an example, the sequence-to-sequence transformer does not have a decoder.

In an example, where the activities are human gestures, the method 400 may include the additional operations of modeling a pose by the human being and extracting skeletal key points from the pose. In an example, the skeletal key points of the pose are provided as input to the sequence-to-sequence transformer.

In an example, where the activities are signs in a sign language, the labels are glosses for the sign language.

At operation 415, the set of labels are communicated (e.g., sent, transmitted, saved to storage, written to a bus, displayed, etc.).

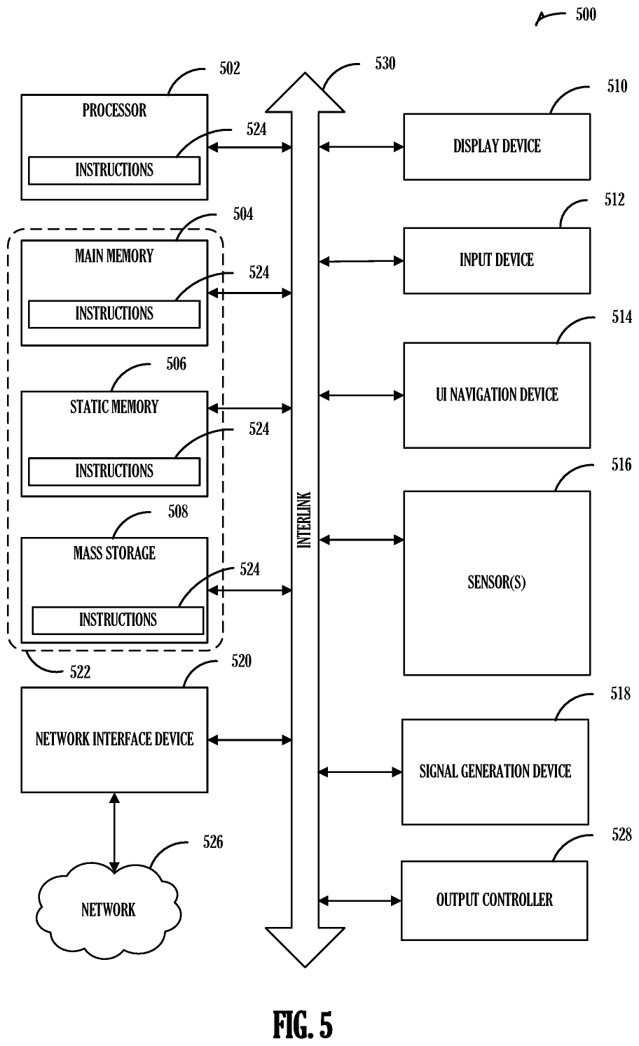

FIG. 5 illustrates a block diagram of an example machine 500 upon which any one or more of the techniques (e.g., methodologies) discussed herein may perform. Examples, as described herein, may include, or may operate by, logic or a number of components, or mechanisms in the machine 500. Circuitry (e.g., processing circuitry) is a collection of circuits implemented in tangible entities of the machine 500 that include hardware (e.g., simple circuits, gates, logic, etc.). Circuitry membership may be flexible over time. Circuitries include members that may, alone or in combination, perform specified operations when operating. In an example, hardware of the circuitry may be immutably designed to carry out a specific operation (e.g., hardwired). In an example, the hardware of the circuitry may include variably connected physical components (e.g., execution units, transistors, simple circuits, etc.) including a machine readable medium physically modified (e.g., magnetically, electrically, moveable placement of invariant massed particles, etc.) to encode instructions of the specific operation. In connecting the physical components, the underlying electrical properties of a hardware constituent are changed, for example, from an insulator to a conductor or vice versa. The instructions enable embedded hardware (e.g., the execution units or a loading mechanism) to create members of the circuitry in hardware via the variable connections to carry out portions of the specific operation when in operation. Accordingly, in an example, the machine readable medium elements are part of the circuitry or are communicatively coupled to the other components of the circuitry when the device is operating. In an example, any of the physical components may be used in more than one member of more than one circuitry. For example, under operation, execution units may be used in a first circuit of a first circuitry at one point in time and reused by a second circuit in the first circuitry, or by a third circuit in a second circuitry at a different time. Additional examples of these components with respect to the machine 500 follow.

In alternative embodiments, the machine 500 may operate as a standalone device or may be connected (e.g., networked) to other machines. In a networked deployment, the machine 500 may operate in the capacity of a server machine, a client machine, or both in server-client network environments. In an example, the machine 500 may act as a peer machine in peer-to-peer (P2P) (or other distributed) network environment. The machine 500 may be a personal computer (PC), a tablet PC, a set-top box (STB), a personal digital assistant (PDA), a mobile telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein, such as cloud computing, software as a service (SaaS), other computer cluster configurations.

The machine (e.g., computer system) 500 may include a hardware processor 502 (e.g., a central processing unit (CPU), a graphics processing unit (GPU), a hardware processor core, or any combination thereof), a main memory 504, a static memory (e.g., memory or storage for firmware, microcode, a basic-input-output (BIOS), unified extensible firmware interface (UEFI), etc.) 506, and mass storage 508 (e.g., hard drives, tape drives, flash storage, or other block devices) some or all of which may communicate with each other via an interlink (e.g., bus) 530. The machine 500 may further include a display unit 510, an alphanumeric input device 512 (e.g., a keyboard), and a user interface (UI) navigation device 514 (e.g., a mouse). In an example, the display unit 510, input device 512 and UI navigation device 514 may be a touch screen display. The machine 500 may additionally include a storage device (e.g., drive unit) 508, a signal generation device 518 (e.g., a speaker), a network interface device 520, and one or more sensors 516, such as a global positioning system (GPS) sensor, compass, accelerometer, or other sensor. The machine 500 may include an output controller 528, such as a serial (e.g., universal serial bus (USB), parallel, or other wired or wireless (e.g., infrared (IR), near field communication (NFC), etc.) connection to communicate or control one or more peripheral devices (e.g., a printer, card reader, etc.).

Registers of the processor 502, the main memory 504, the static memory 506, or the mass storage 508 may be, or include, a machine readable medium 522 on which is stored one or more sets of data structures or instructions 524 (e.g., software) embodying or utilized by any one or more of the techniques or functions described herein. The instructions 524 may also reside, completely or at least partially, within any of registers of the processor 502, the main memory 504, the static memory 506, or the mass storage 508 during execution thereof by the machine 500. In an example, one or any combination of the hardware processor 502, the main memory 504, the static memory 506, or the mass storage 508 may constitute the machine readable media 522. While the machine readable medium 522 is illustrated as a single medium, the term “machine readable medium” may include a single medium or multiple media (e.g., a centralized or distributed database, and/or associated caches and servers) configured to store the one or more instructions 524.

The term “machine readable medium” may include any medium that is capable of storing, encoding, or carrying instructions for execution by the machine 500 and that cause the machine 500 to perform any one or more of the techniques of the present disclosure, or that is capable of storing, encoding or carrying data structures used by or associated with such instructions. Non-limiting machine readable medium examples may include solid-state memories, optical media, magnetic media, and signals (e.g., radio frequency signals, other photon based signals, sound signals, etc.). In an example, a non-transitory machine readable medium comprises a machine readable medium with a plurality of particles having invariant (e.g., rest) mass, and thus are compositions of matter. Accordingly, non-transitory machine-readable media are machine readable media that do not include transitory propagating signals. Specific examples of non-transitory machine readable media may include: non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; and CD-ROM and DVD-ROM disks.

In an example, information stored or otherwise provided on the machine readable medium 522 may be representative of the instructions 524, such as instructions 524 themselves or a format from which the instructions 524 may be derived. This format from which the instructions 524 may be derived may include source code, encoded instructions (e.g., in compressed or encrypted form), packaged instructions (e.g., split into multiple packages), or the like. The information representative of the instructions 524 in the machine readable medium 522 may be processed by processing circuitry into the instructions to implement any of the operations discussed herein. For example, deriving the instructions 524 from the information (e.g., processing by the processing circuitry) may include: compiling (e.g., from source code, object code, etc.), interpreting, loading, organizing (e.g., dynamically or statically linking), encoding, decoding, encrypting, unencrypting, packaging, unpackaging, or otherwise manipulating the information into the instructions 524.

In an example, the derivation of the instructions 524 may include assembly, compilation, or interpretation of the information (e.g., by the processing circuitry) to create the instructions 524 from some intermediate or preprocessed format provided by the machine readable medium 522. The information, when provided in multiple parts, may be combined, unpacked, and modified to create the instructions 524. For example, the information may be in multiple compressed source code packages (or object code, or binary executable code, etc.) on one or several remote servers. The source code packages may be encrypted when in transit over a network and decrypted, uncompressed, assembled (e.g., linked) if necessary, and compiled or interpreted (e.g., into a library, stand-alone executable etc.) at a local machine, and executed by the local machine.

The instructions 524 may be further transmitted or received over a communications network 526 using a transmission medium via the network interface device 520 utilizing any one of a number of transfer protocols (e.g., frame relay, internet protocol (IP), transmission control protocol (TCP), user datagram protocol (UDP), hypertext transfer protocol (HTTP), etc.). Example communication networks may include a local area network (LAN), a wide area network (WAN), a packet data network (e.g., the Internet), LoRa/LoRaWAN, or satellite communication networks, mobile telephone networks (e.g., cellular networks such as those complying with 3G, 4G LTE/LTE-A, or 5G standards), Plain Old Telephone (POTS) networks, and wireless data networks (e.g., Institute of Electrical and Electronics Engineers (IEEE) 802.11 family of standards known as Wi-Fi®, IEEE 802.15.4 family of standards, peer-to-peer (P2P) networks, among others. In an example, the network interface device 520 may include one or more physical jacks (e.g., Ethernet, coaxial, or phone jacks) or one or more antennas to connect to the communications network 526. In an example, the network interface device 520 may include a plurality of antennas to wirelessly communicate using at least one of single-input multiple-output (SIMO), multiple-input multiple-output (MIMO), or multiple-input single-output (MISO) techniques. The term “transmission medium” shall be taken to include any intangible medium that is capable of storing, encoding or carrying instructions for execution by the machine 500, and includes digital or analog communications signals or other intangible medium to facilitate communication of such software. A transmission medium is a machine readable medium.

### ADDITIONAL NOTES & EXAMPLES

Example 1 is an apparatus for a sequence recognition in video, the apparatus comprising: a memory including instructions; and processing circuitry that, when in operation, is configured by the instructions to: obtain video that includes a sequence of activities; invoke a sequence-to-sequence transformer on the video to produce a set of labels that correspond to activities in the sequence of activities; and communicate the set of labels.

In Example 2, the subject matter of Example 1, wherein the sequence-to-sequence transformer is configured to use chunk-wise attention.

In Example 3, the subject matter of Example 2, wherein chunk-wise attention includes: dividing inputs into chunks; and applying attention within a chunk.

In Example 4, the subject matter of any of Examples 2-3, wherein an input layer also uses local attention from neighboring chunks.

In Example 5, the subject matter of any of Examples 2-4, wherein attention in the sequence-to-sequence transformer is bi-directional with respect to time for input to the sequence-to-sequence transformer.

In Example 6, the subject matter of any of Examples 2-5, wherein position encodings of the sequence-to-sequence transformer are relative with respect to self-attention calculations.

In Example 7, the subject matter of any of Examples 1-6, wherein the sequence-to-sequence transformer does not have a decoder.

In Example 8, the subject matter of any of Examples 1-7, wherein the activities are gestures by a human being.

In Example 9, the subject matter of Example 8, wherein the processing circuitry is configured to: model a pose by the human being; extract skeletal key points from the pose; and provide the skeletal key points of the pose as input to the sequence-to-sequence transformer.

In Example 10, the subject matter of any of Examples 8-9, wherein the activities are signs in a sign language.

In Example 11, the subject matter of Example 10, wherein members of the set of labels are glosses for the sign language.

Example 12 is a method for a sequence recognition in video, the method comprising: obtaining video that includes a sequence of activities; invoking a sequence-to-sequence transformer on the video to produce a set of labels that correspond to activities in the sequence of activities; and communicating the set of labels.

In Example 13, the subject matter of Example 12, wherein the sequence-to-sequence transformer is configured to use chunk-wise attention.

In Example 14, the subject matter of Example 13, wherein chunk-wise attention includes: dividing inputs into chunks; and applying attention within a chunk.

In Example 15, the subject matter of any of Examples 13-14, wherein an input layer also uses local attention from neighboring chunks.

In Example 16, the subject matter of any of Examples 13-15, wherein attention in the sequence-to-sequence transformer is bi-directional with respect to time for input to the sequence-to-sequence transformer.

In Example 17, the subject matter of any of Examples 13-16, wherein position encodings of the sequence-to-sequence transformer are relative with respect to self-attention calculations.

In Example 18, the subject matter of any of Examples 12-17, wherein the sequence-to-sequence transformer does not have a decoder.

In Example 19, the subject matter of any of Examples 12-18, wherein the activities are gestures by a human being.

In Example 20, the subject matter of Example 19, comprising: modeling a pose by the human being; extracting skeletal key points from the pose; and providing the skeletal key points of the pose as input to the sequence-to-sequence transformer.

In Example 21, the subject matter of any of Examples 19-20, wherein the activities are signs in a sign language.

In Example 22, the subject matter of Example 21, wherein members of the set of labels are glosses for the sign language.

Example 23 is at least one machine readable medium including instructions for a sequence recognition in video, The instructions, when executed by processing circuitry, cause the processing circuitry to perform operations comprising: obtaining video that includes a sequence of activities; invoking a sequence-to-sequence transformer on the video to produce a set of labels that correspond to activities in the sequence of activities; and communicating the set of labels.

In Example 24, the subject matter of Example 23, wherein the sequence-to-sequence transformer is configured to use chunk-wise attention.

In Example 25, the subject matter of Example 24, wherein chunk-wise attention includes: dividing inputs into chunks; and applying attention within a chunk.

In Example 26, the subject matter of any of Examples 24-25, wherein an input layer also uses local attention from neighboring chunks.

In Example 27, the subject matter of any of Examples 24-26, wherein attention in the sequence-to-sequence transformer is bi-directional with respect to time for input to the sequence-to-sequence transformer.

In Example 28, the subject matter of any of Examples 24-27, wherein position encodings of the sequence-to-sequence transformer are relative with respect to self-attention calculations.

In Example 29, the subject matter of any of Examples 23-28, wherein the sequence-to-sequence transformer does not have a decoder.

In Example 30, the subject matter of any of Examples 23-29, wherein the activities are gestures by a human being.

In Example 31, the subject matter of Example 30, wherein the operations comprise: modeling a pose by the human being; extracting skeletal key points from the pose; and providing the skeletal key points of the pose as input to the sequence-to-sequence transformer.

In Example 32, the subject matter of any of Examples 30-31, wherein the activities are signs in a sign language.

In Example 33, the subject matter of Example 32, wherein members of the set of labels are glosses for the sign language.

Example 34 is a system for a sequence recognition in video, the system comprising: means for obtaining video that includes a sequence of activities; means for invoking a sequence-to-sequence transformer on the video to produce a set of labels that correspond to activities in the sequence of activities; and means for communicating the set of labels.

In Example 35, the subject matter of Example 34, wherein the sequence-to-sequence transformer is configured to use chunk-wise attention.

In Example 36, the subject matter of Example 35, wherein chunk-wise attention includes: dividing inputs into chunks; and applying attention within a chunk.

In Example 37, the subject matter of any of Examples 35-36, wherein an input layer also uses local attention from neighboring chunks.

In Example 38, the subject matter of any of Examples 35-37, wherein attention in the sequence-to-sequence transformer is bi-directional with respect to time for input to the sequence-to-sequence transformer.

In Example 39, the subject matter of any of Examples 35-38, wherein position encodings of the sequence-to-sequence transformer are relative with respect to self-attention calculations.

In Example 40, the subject matter of any of Examples 34-39, wherein the sequence-to-sequence transformer does not have a decoder.

In Example 41, the subject matter of any of Examples 34-40, wherein the activities are gestures by a human being.

In Example 42, the subject matter of Example 41, comprising: means for modeling a pose by the human being; means for extracting skeletal key points from the pose; and means for providing the skeletal key points of the pose as input to the sequence-to-sequence transformer.

In Example 43, the subject matter of any of Examples 41-42, wherein the activities are signs in a sign language.

In Example 44, the subject matter of Example 43, wherein members of the set of labels are glosses for the sign language.

Example 45 is at least one machine readable medium including instructions to implement a sequence-to-sequence transformer, the sequence-to-sequence transformer comprising: an input-embedding layer configured to encode an input sequence to an encoded input sequence; and an encoder neural network comprising one or more encoder subnetworks including a base encoder subnetwork that accepts the encoded input sequence as input, an encoder subnetwork comprising: an encoder self-attention sub-layer that is configured to: receive subnetwork input; and apply a local-chunk attention mechanism over the subnetwork input to generate queries, keys and values, the local-chunk attention mechanism restricting an attention mechanism for a neuron of the encoder subnetwork to a subset of the subnetwork input based on a predetermined chunk size; and a feedforward sub-layer that is configured to: apply a transformation to the subnetwork input based on the queries, keys, and values to produce encoder subnetwork output; and transmit the encoder subnetwork output to a recipient.

In Example 46, the subject matter of Example 45, wherein the encoder self-attention sub-layer for the base encoder subnetwork is configured to expand the attention mechanism to include a portion of the subnetwork input that adjacent to the subset of the subnetwork input.

In Example 47, the subject matter of Example 46, wherein the portion of the subnetwork input is a predetermined fixed number of elements of the subnetwork input.

In Example 48, the subject matter of any of Examples 45-47, wherein the local-chunk attention mechanism is bi-directional.

In Example 49, the subject matter of any of Examples 45-48, wherein the sequence-to-sequence transformer does not include a decoder neural network.

In Example 50, the subject matter of any of Examples 45-49, wherein, to encode the input sequence, the input-embedding layer is configured to apply relative positional encoding to the input sequence.

In Example 51, the subject matter of Example 50, wherein the relative positional encoding are bi-directional.

In Example 52, the subject matter of any of Examples 45-51, wherein the input sequence comprises video frames.

In Example 53, the subject matter of Example 52, wherein the predetermined chunk size is a number of video frames that are equivalent to a second.

Example 54 is at least one machine-readable medium including instructions that, when executed by processing circuitry, cause the processing circuitry to perform operations to implement of any of Examples 1-53.

Example 55 is an apparatus comprising means to implement of any of Examples 1-53.

Example 56 is a system to implement of any of Examples 1-53.

Example 57 is a method to implement of any of Examples 1-53.

The above detailed description includes references to the accompanying drawings, which form a part of the detailed description. The drawings show, by way of illustration, specific embodiments that may be practiced. These embodiments are also referred to herein as “examples.” Such examples may include elements in addition to those shown or described. However, the present inventors also contemplate examples in which only those elements shown or described are provided. Moreover, the present inventors also contemplate examples using any combination or permutation of those elements shown or described (or one or more aspects thereof), either with respect to a particular example (or one or more aspects thereof), or with respect to other examples (or one or more aspects thereof) shown or described herein.

All publications, patents, and patent documents referred to in this document are incorporated by reference herein in their entirety, as though individually incorporated by reference. In the event of inconsistent usages between this document and those documents so incorporated by reference, the usage in the incorporated reference(s) should be considered supplementary to that of this document; for irreconcilable inconsistencies, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In the appended claims, the terms “including” and “in which” are used as the plain-English equivalents of the respective terms “comprising” and “wherein.” Also, in the following claims, the terms “including” and “comprising” are open-ended, that is, a system, device, article, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

The above description is intended to be illustrative, and not restrictive. For example, the above-described examples (or one or more aspects thereof) may be used in combination with each other. Other embodiments may be used, such as by one of ordinary skill in the art upon reviewing the above description. The Abstract is to allow the reader to quickly ascertain the nature of the technical disclosure and is submitted with the understanding that it will not be used to interpret or limit the scope or meaning of the claims. Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed embodiment. Thus, the following claims are hereby incorporated into the Detailed Description, with each claim standing on its own as a separate embodiment. The scope of the embodiments should be determined with reference to the appended claims, along with the full scope of equivalents to which such claims are entitled.

1. An apparatus for a sequence recognition in video, the apparatus comprising:
a memory including instructions; and
processing circuitry that, when in operation, is configured by the instructions to:
obtain video that includes a sequence of activities;
invoke a sequence-to-sequence transformer on the video to produce a set of labels that correspond to activities in the sequence of activities; and
communicate the set of labels.

2. The apparatus of claim 1, wherein the sequence-to-sequence transformer is configured to use chunk-wise attention.

3. The apparatus of claim 2, wherein chunk-wise attention includes:
dividing inputs into chunks; and
applying attention within a chunk.

4. The apparatus of claim 2, wherein an input layer also uses local attention from neighboring chunks.

5. The apparatus of claim 2, wherein attention in the sequence-to-sequence transformer is bi-directional with respect to time for input to the sequence-to-sequence transformer.

6. The apparatus of claim 2, wherein position encodings of the sequence-to-sequence transformer are relative with respect to self-attention calculations.

7. The apparatus of claim 1, wherein the sequence-to-sequence transformer does not have a decoder.

8. The apparatus of claim 1, wherein the activities are gestures by a human being.

9. The apparatus of claim 8, wherein the processing circuitry is configured to:
model a pose by the human being;
extract skeletal key points from the pose; and
provide the skeletal key points of the pose as input to the sequence-to-sequence transformer.

10. The apparatus of claim 8, wherein the activities are signs in a sign language.

11. The apparatus of claim 10, wherein members of the set of labels are glosses for the sign language.

12. At least one non-transitory machine readable medium including instructions to implement a sequence-to-sequence transformer, the sequence-to-sequence transformer comprising:
an input-embedding layer configured to encode an input sequence to an encoded input sequence; and
an encoder neural network comprising one or more encoder subnetworks including a base encoder subnetwork that accepts the encoded input sequence as input, an encoder subnetwork comprising:
an encoder self-attention sub-layer that is configured to:
receive subnetwork input; and
apply a local-chunk attention mechanism over the subnetwork input to generate queries, keys and values, the local-chunk attention mechanism restricting an attention mechanism for a neuron of the encoder subnetwork to a subset of the subnetwork input based on a predetermined chunk size; and
a feedforward sub-layer that is configured to:
apply a transformation to the subnetwork input based on the queries, keys, and values to produce encoder subnetwork output; and
transmit the encoder subnetwork output to a recipient.

13. The at least one non-transitory machine readable medium of claim 12, wherein the encoder self-attention sub-layer for the base encoder subnetwork is configured to expand the attention mechanism to include a portion of the subnetwork input that adjacent to the subset of the subnetwork input.

14. The at least one non-transitory machine readable medium of claim 13, wherein the portion of the subnetwork input is a predetermined fixed number of elements of the subnetwork input.

15. The at least one non-transitory machine readable medium of claim 12, wherein the local-chunk attention mechanism is bi-directional.

16. The at least one non-transitory machine readable medium of claim 12, wherein the sequence-to-sequence transformer does not include a decoder neural network.

17. The at least one non-transitory machine readable medium of claim 12, wherein, to encode the input sequence, the input-embedding layer is configured to apply relative positional encoding to the input sequence.

18. The at least one non-transitory machine readable medium of claim 17, wherein the relative positional encoding are bi-directional.

19. The at least one non-transitory machine readable medium of claim 12, wherein the input sequence comprises video frames.

20. The at least one non-transitory machine readable medium of claim 19, wherein the predetermined chunk size is a number of video frames that are equivalent to a second.
